(19) United States
(12) Patent Application Publication
(10) Pub. No.: US 2025/0305332 A1
(43) Pub. Date: Oct. 2, 2025

(54) Utility Vehicle

(71) Applicant: Kubota Corporation, Osaka-shi (JP)

(72) Inventors: Yuji Ishii, Osaka (JP); Rui Hiroto, Osaka (JP)

(21) Appl. No.: 18/969,514

(22) Filed: Dec. 5, 2024

(30) Foreign Application Priority Data
Mar. 26, 2024 (JP) 2024-050019

(51) Int. Cl. E05B 83/16; B62D 33/027

(52) U.S. Cl. CPC E05B 83/16; B62D 33/0273

(57) ABSTRACT

A utility vehicle includes a body frame; a front wheel and a rear wheel supporting the body frame relative to ground; a cargo box including: a floor plate; a pair of left and right side covers; and a tail gate, the cargo box being supported by the body frame in such a manner as to be swingable into a dumping orientation; a swing mechanism configured to swing the tail gate between a closed position and an open position about a lateral swing axis at a lower end area of the tail gate; and a pair of left and right elastic coupling units each including an elastic element and configured to couple the tail gate in the closed position to a corresponding one of the side covers with the elastic element in-between.

### CROSS-REFERENCE TO RELATED APPLICATION

This application claims priority to Japanese Patent Application No. 2024-050019 filed Mar. 26, 2024, the disclosure of which is hereby incorporated by reference in its entirety.

### BACKGROUND OF THE INVENTION

### Field of the Invention

The present invention relates to a utility vehicle including a body frame and a cargo box supported by the body frame and including a floor plate, a pair of left and right side covers, and a tail gate.

### Description of Related Art

U.S. Pat. No. 10,618,572 (FIGS. 15 and 17) discloses a utility vehicle with a cargo box including a floor plate, a front plate, a pair of left and right side covers, and a tail gate. The utility vehicle includes a gate support disposed below the back end of the cargo box and supporting the tail gate with a shaft in-between such that the tail gate is swingable about the shaft from an upward, closed position (that is, an upright orientation) to a lower, open position (that is, a horizontal orientation). The utility vehicle includes a pair of left and right couplers configured to couple and lock the tail gate in the upright position to the respective side covers and a pair of left and right wires coupled to the tail gate and the respective side covers. Unlocking the lock mechanisms allows the tail gate to swing downward, until the tail gate is held horizontally in the open position by the wires.

The utility vehicle disclosed in U.S. Pat. No. 10,618,572 allows the tail gate in the upright position to be coupled to the side covers. The tail gate may come into contact with the side covers, thus causing rattling noise. In particular, driving the utility vehicle shakes the vehicle body, which in turn shakes the side covers laterally and inevitably causes rattling noise.

### SUMMARY OF THE INVENTION

The present invention has an object of providing a utility vehicle with reduced rattling noise. A utility vehicle according to the present invention includes: a body frame; a front wheel and a rear wheel supporting the body frame relative to ground; a cargo box including: a floor plate; a pair of left and right side covers; and a tail gate, the cargo box being supported by the body frame in such a manner as to be swingable into a dumping orientation; a swing mechanism configured to swing the tail gate between a closed position and an open position about a lateral swing axis at a lower end area of the tail gate; and a pair of left and right elastic coupling units each including an elastic element and configured to couple the tail gate in the closed position to a corresponding one of the side covers with the elastic element in-between.

With the above configuration, the tail gate is configured to be coupled to each side cover with an elastic element in-between so as not to come into direct contact with the side covers. The elastic coupling units absorb shakes of the tail gate and the side covers. The above configuration thereby prevents rattling noise from being caused by contact between the tail gate and the side covers.

The utility vehicle may be configured such that the elastic coupling units each include: as the elastic element, an elastic plug having an insertion hole; and an insertion rod insertable into the insertion hole as the tail gate swings into the closed position. This configuration allows the outer surface of the insertion rod to be in close contact with the surface that defines the insertion hole. This in turn allows the elastic coupling units, even if small, to reliably couple the tail gate to the side covers, and further reduces noise such as rattling noise.

The utility vehicle may be configured such that the elastic plug has a conical guide surface, and the insertion hole has a hole diameter equivalent to a diameter of the insertion rod and has an insertion-side opening area so defined by the conical guide surface as to become gradually reduced to the hole diameter. This configuration allows the insertion rod to be guided by the conical guide surface to enter the insertion hole as the tail gate swings from a downward position to the upright position to be closed. This allows the insertion rod to be inserted smoothly. Further, if the insertion rod has a base end portion circumferentially welded to a support, the above configuration allows the circumferentially welded portion to be received by the conical guide surface. This allows the insertion rod to be stably coupled to the elastic plug.

The utility vehicle may be configured such that the insertion rod of the left elastic coupling unit is fixed to a back end portion of the left side cover, the insertion rod of the right elastic coupling unit is fixed to a back end portion of the right side cover, the elastic plug of the left elastic coupling unit is fixed to a left end portion of the tail gate, and the elastic plug of the right elastic coupling unit is fixed to a right end portion of the tail gate. This configuration ensures that the elastic plugs and the insertion rods are fixed firmly, as the cargo box is structurally firm at its corners, namely the back end portion of each side cover and the left and right end portions of the tail gate, for increased strength.

The utility vehicle may be configured such that the insertion rods are off a line of flow of loading and unloading a cargo onto and from the floor plate. This configuration prevents the elastic coupling units, in particular the insertion rods, from hindering loading and unloading of cargos onto and from the floor plate with the tail gate in the open position.

An openable and closable tail gate is typically locked to side covers with use of respective lock mechanisms to remain in an upright position and prevent a cargo in a cargo box from falling off. If the lock mechanisms lock the tail gate to the respective side covers in such a manner that the tail gate is in constant contact with the side covers, it will lead to rattling noise. If the tail gate is apart from the side covers by a gap in the locked state which gap is larger than the maximum elastic deformation of elastic coupling units, the elastic coupling units will receive all force applied to open the tail gate. This will render the lock mechanisms meaningless and may cause the elastic coupling units to receive a critically large force. The utility vehicle may thus include: a pair of left and right lock mechanisms configured to lock the tail gate in the closed position to the respective side covers, the lock mechanisms each include: a first lock member; and a second lock member configured to receive the first lock member, and with the elastic coupling units each coupling the tail gate to the corresponding one of the side covers, the first lock member is apart from the second lock member by a gap smaller than maximum elastic deformation of the elastic coupling unit.

### BRIEF DESCRIPTION OF THE DRAWINGS

FIG. 1 is a side view of a utility vehicle.

FIG. 2 is a plan view of a utility vehicle.

FIG. 3 is an enlarged view of a backward area of a cargo box.

FIG. 4 is an enlarged view of a tail gate in a horizontal orientation.

FIG. 5 is an enlarged view of a tail gate inclined downward.

FIG. 6 is a perspective view of a side cover and an insertion rod thereon.

FIG. 7 is a perspective view of a tail gate and an elastic plug thereon.

FIG. 8 is a perspective view of an elastic coupling unit from backward relative to the vehicle body.

FIG. 9 provides diagrams illustrating how an insertion rod is coupled to an elastic plug.

### DESCRIPTION OF THE INVENTION

The description below deals with a utility vehicle as an embodiment of the present invention. The description below of the utility vehicle refers to the drawings, which show arrow F to indicate the forward direction relative to the vehicle body, arrow B to indicate the backward direction relative to the vehicle body, arrow U to indicate the upward direction relative to the vehicle body, arrow D to indicate the downward direction relative to the vehicle body, arrow L to indicate the leftward direction relative to the vehicle body, and arrow R to indicate the rightward direction relative to the vehicle body.

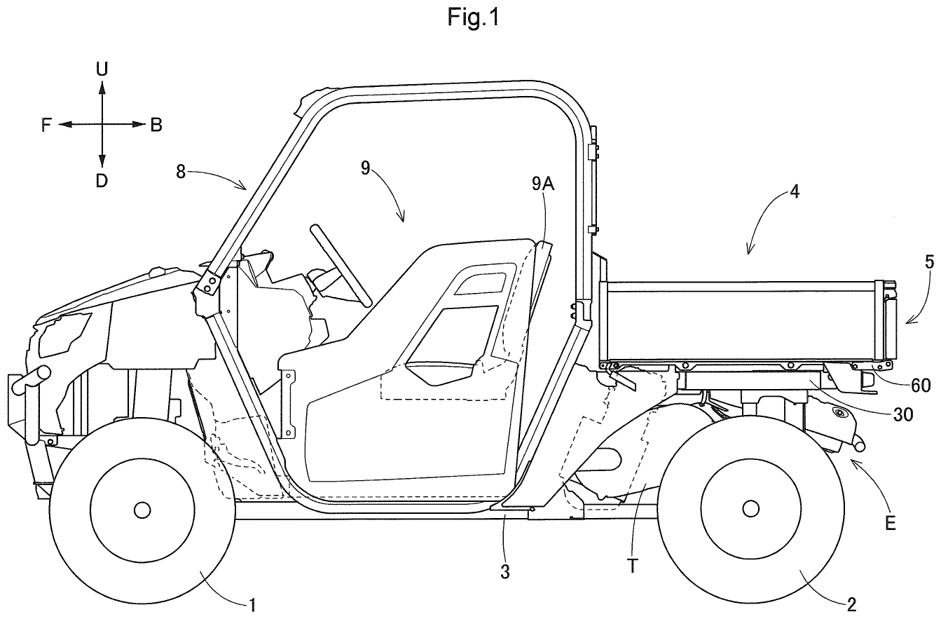

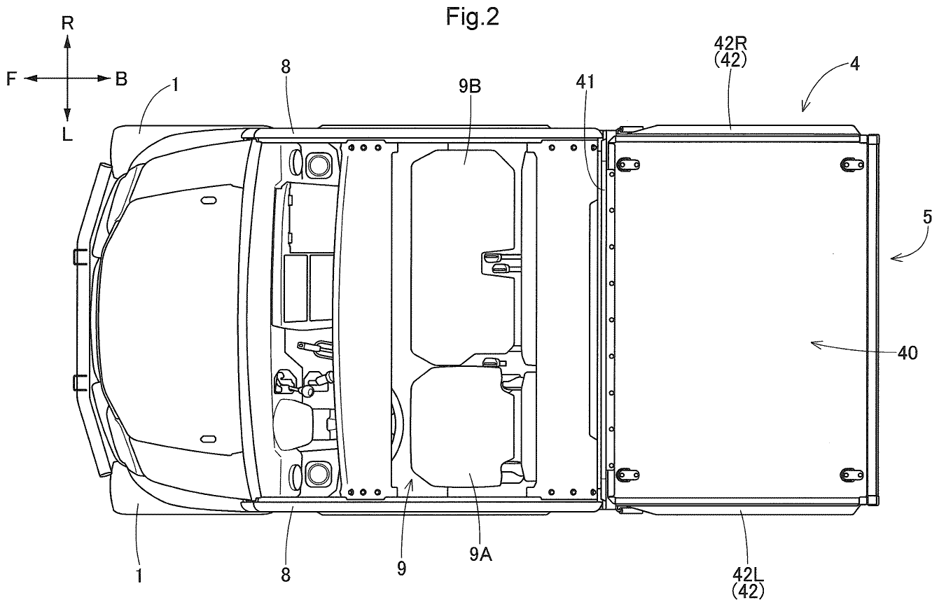

As illustrated in FIG. 1, the utility vehicle includes a pair of left and right drivable and turnable front wheels 1, a pair of left and right drivable rear wheels 2, and a body frame 3 provided with the front and rear wheels 1 and 2. The utility vehicle includes a driver section 9 at a front portion of the body frame 3, a cargo box 4 at a back portion of the body frame 3, and a roll-over protective structure 8 covering the driver section 9. The driver section 9 includes a driver's seat 9A and an occupant's seat 9B (see FIG. 2) as well as components such as a steering wheel and an instrument panel forward of the driver's seat 9A. The utility vehicle includes components such as an engine E and a transmission T below the cargo box 4.

As illustrated in FIG. 2, the cargo box 4 includes a floor plate 40, a front plate 41, two side covers 42 (namely, a left side cover 42L and a right side cover 42R), and a tail gate 5.

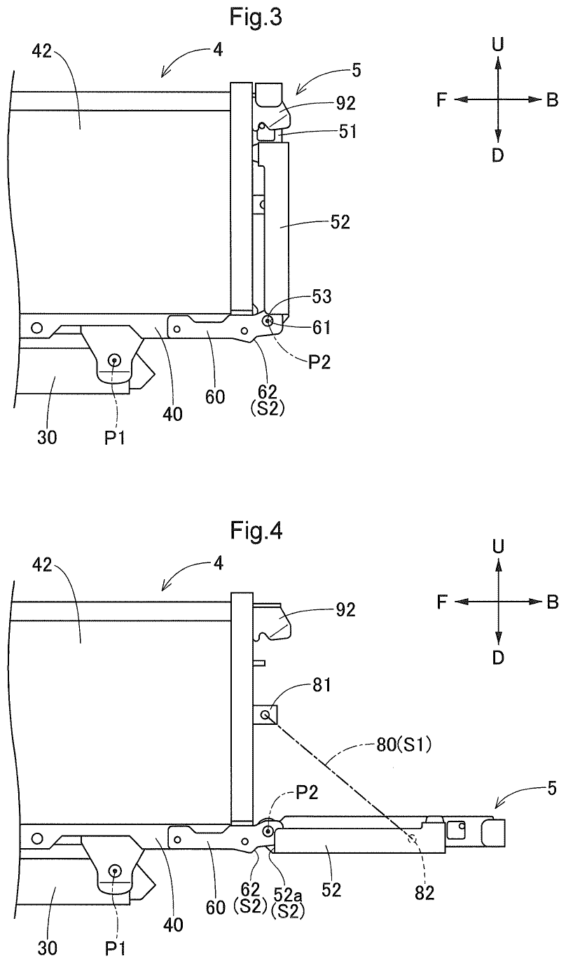

As illustrated in FIGS. 1 and 3, the body frame 3 includes at an upper back portion thereof a cargo box frame member 30 supporting the cargo box 4 in such a manner that the cargo box 4 is movable into a dumping orientation. The utility vehicle includes a swing mechanism 6 configured to swing the cargo box 4 into a dumping orientation. The swing mechanism 6 is of a type so well-known as to require no detailed description, and is configured to swing upward by approximately 50 degrees about a horizontal or lateral dump axis P1 at a lower end area of a back portion of the cargo box 4 in response to receiving motive power from an actuator (not illustrated in the drawings).

As illustrated in FIG. 3, the tail gate 5 includes a gate plate 51, a pair of left and right gate supportive columns 52 fixed to respective left and right ends of the gate plate 51 and each having a channel-shaped cross section, and a pair of left and right horizontal or lateral gate swing shafts 53 at respective lower end areas of the gate supportive columns 52. The utility vehicle includes a pair of left and right gate brackets 60 fixed to respective left and right back end areas of the frame of the floor plate 40 and each having a through hole 61 through which the corresponding gate swing shaft 53 has its free end portion. The gate swing shafts 53 share an axis serving as a lateral swing axis P2 about which the tail gate 5 is swingable downward, meaning that the swing mechanism 6, which is configured to swing the tail gate 5 downward, is made up of the gate swing shafts 53 and the gate brackets 60. This structure may be altered such that the gate swing shafts 53 are fixed to the respective gate brackets 60 and that the tail gate 5 has through holes.

The swing mechanism 6 includes a first stopper S1 configured to hold the tail gate 5 in a first position defined by a first swing angle and a second stopper S2 configured to hold the tail gate 5 in a second position defined by a second swing angle larger than the first swing angle.

As illustrated in FIG. 4, the first stopper S1 is configured to hold the tail gate 5 horizontally in the first position (that is, the position defined by the first swing angle) while the tail gate 5 is swinging from an upright position as a closed position toward a downward position as an open position. The first stopper S1 includes a pair of left and right first metal fittings 81 at respective back ends of the left and right side covers 42L and 42R, a pair of left and right second metal fittings 82 at respective left and right ends of the tail gate 5, and a pair of left and right holding wires 80 each having a first end attached to the corresponding first metal fitting 81 and a second end attached to the corresponding second metal fitting 82. The holding wires 80 for the present embodiment each have a first end fixed to the corresponding first metal fitting 81 and a second end removably hooked on the corresponding second metal fitting 82. The holding wires 80 may alternatively each have a first end removably hooked on the corresponding first metal fitting 81 and a second end fixed to the corresponding second metal fitting 82. The first stopper S1 is configured to hold the tail gate 5 horizontally while the tail gate 5 is swinging downward from the upright position. The tail gate 5, when held horizontally, forms a horizontal surface together with the floor plate 40 to extend the bottom area of the cargo box 4. The first stopper S1 for the present embodiment includes wires, but may alternatively include lock pins to temporarily hold the tail gate 5 horizontally.

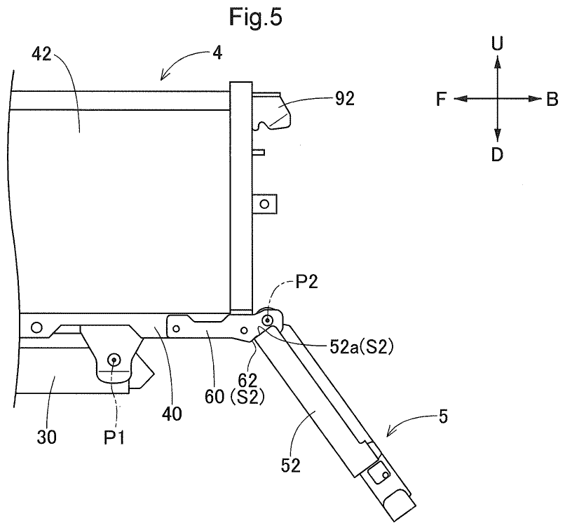

Removing the holding wires 80 from the respective first metal fittings 81 or the respective second metal fittings 82 allows the tail gate 5 to swing further downward from the first position as illustrated in FIG. 5 until the tail gate 5 is stopped by the second stopper S2. The second stopper S2 is configured to hold the tail gate 5 in a second position defined by a second swing angle larger than and below the first swing angle.

The second stopper S2 is made up of a portion of each gate bracket 60 and a portion of each gate supportive column 52, which is included in the tail gate 5. The second stopper S2 is, in other words, a combination of already existing components. As illustrated in FIGS. 3 and 5, the gate supportive columns 52 each have a first contact surface 52a at a lower end, whereas the gate brackets 60 are each in the form of an elongated plate with different sides including an inclined side as a second contact surface 62 for contact with the first contact surface 52a, the first and second contact surfaces 52a and 62 constituting the second stopper S2. In other words, the first contact surface 52a comes into contact with the second contact surface 62 to hold the tail gate 5 in the second position, which is defined by the second swing angle. The tail gate 5 may be held in a desired second position with use of gate supportive columns 52 each processed to have a first contact surface 52a with an intended shape, for example, an intended angle of inclination.

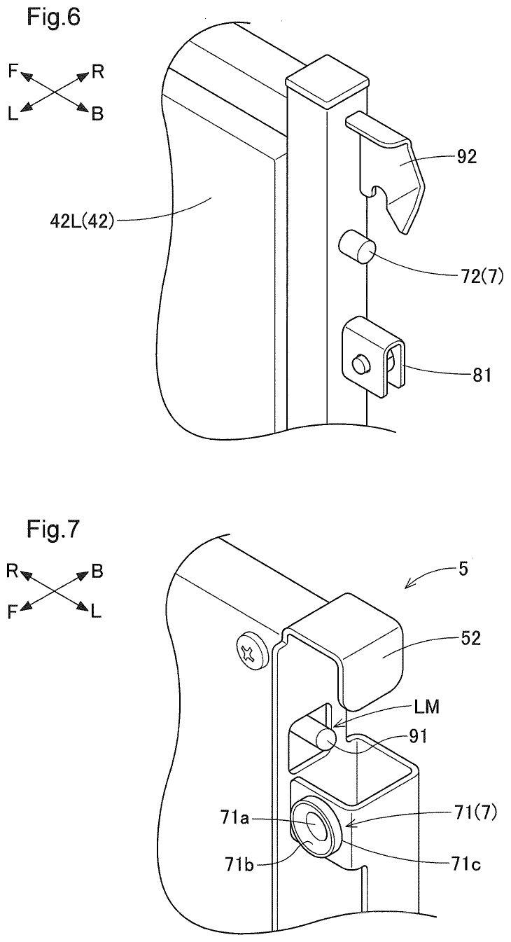

As illustrated in FIGS. 6 to 8, the utility vehicle includes a pair of left and right elastic coupling units 7 disposed between the tail gate 5 and the respective side covers 42 and configured to couple the tail gate 5 in the closed position to the respective side covers 42.

As illustrated in FIG. 6, the elastic coupling units 7 each include an insertion rod 72 for the corresponding side cover 42. The left and right side covers 42L and 42R each include an angular pipe at a back end portion. The insertion rod 72 is circumferentially welded to the back face of the angular pipe of the corresponding side cover 42 to protrude horizontally and backward relative to the vehicle body. Cargos are loaded onto or unloaded from the floor plate 40 with the tail gate 5 in the downward position (that is, in the open position). The insertion rods 72 are so positioned that the elastic coupling units 7 are off the line of flow of loading and unloading cargos and that the insertion rods 72 do not hinder the work.

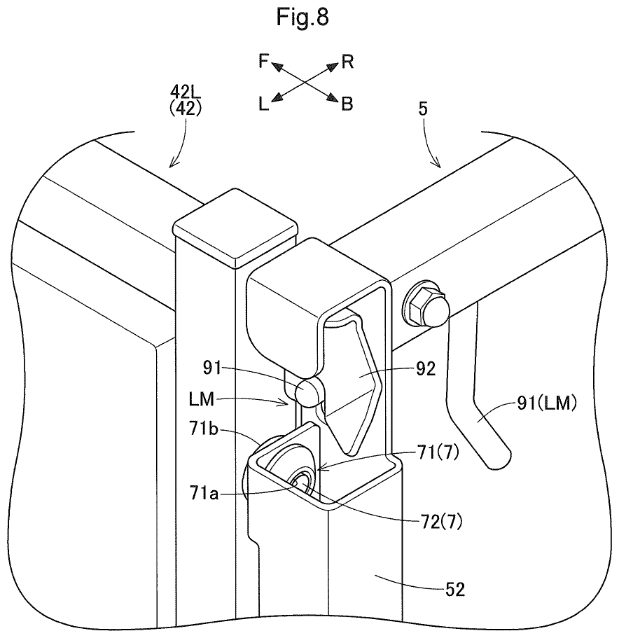

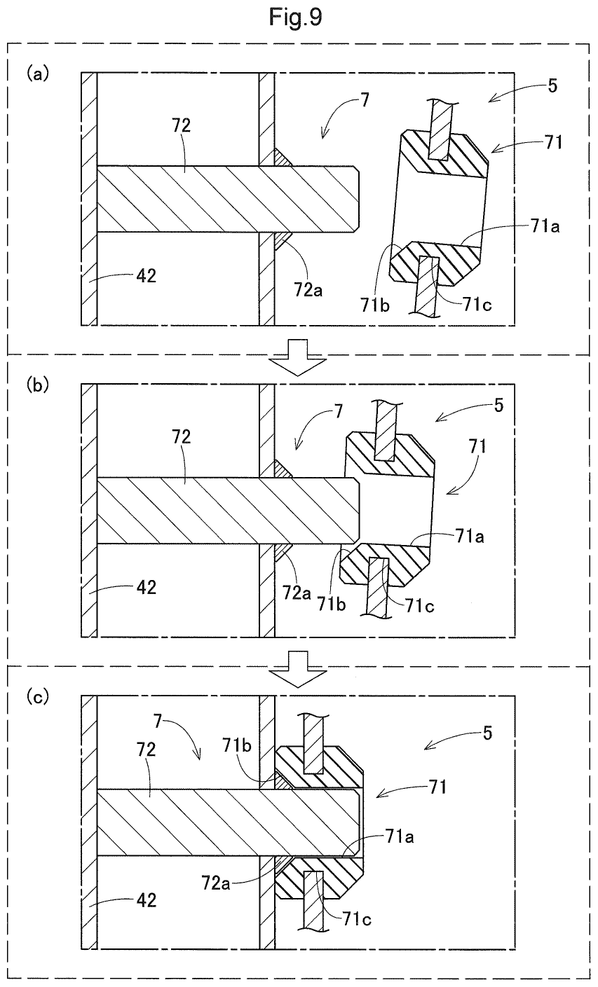

As illustrated in FIGS. 7 and 8, the elastic coupling units 7 each include an elastic plug 71 for the tail gate 5. The elastic plug 71 is made of an elastic material such as rubber and has a circular cross section. The elastic plug 71 has an insertion hole 71a and a conical guide surface 71b. The insertion hole 71a extends along the central axis of the elastic plug 71 and has a hole diameter equivalent to the diameter of each insertion rod 72. The insertion hole 71a also has an insertion-side opening area so defined by the conical guide surface 71b as to have an opening with an opening diameter that becomes gradually reduced to the hole diameter. The insertion rods 72 are each guided by the corresponding conical guide surface 71b to enter the corresponding insertion hole 71a as the tail gate 5 swings into the closed position until the protruding end of the insertion rod 72 is entirely in the insertion hole 71a. In this state, the circumferentially welded portion 72a (see FIG. 9) of the insertion rod 72 is received by the conical guide surface 71b.

The gate supportive columns 52 are at respective left and right end portions of the tail gate 5. The elastic plugs 71 are fixed to the respective front faces of the gate supportive columns 52 relative to the vehicle body. The front faces each have an attachment hole. The elastic plugs 71 each have an outer surface with a ring-shaped groove 71c (see FIG. 9) for the elastic plug 71 to fit in the corresponding attachment hole.

As partially illustrated in FIGS. 7 and 8, the utility vehicle includes a pair of left and right lock mechanisms LM each configured to lock and unlock the tail gate 5 in the upright position to and from the corresponding side cover 42. The lock mechanisms LM each include a first lock member and a second lock member configured to receive the first lock member. The first lock member for the present embodiment is a laterally slidable pin 91 on the tail gate 5. The second lock member for the present embodiment is a hole 92 in the side cover 42. The lock mechanism LM is preferably configured such that in its locked state, the slidable pin 91 is apart from the opening of the hole 92 by a gap smaller than the maximum elastic deformation of the corresponding elastic coupling unit 7.

FIG. 9 illustrates how the insertion rods 72 are each coupled to the corresponding elastic plug 71 as the tail gate 5 swings into the closed position. Section (a) of FIG. 9 shows the tail gate 5 during its swing in a position away from the upright position (in which the tail gate 5 is in the closed position) by an angle of approximately five degrees. The insertion rod 72 has its leading end still away from the insertion hole 71a. Section (b) of FIG. 9 shows the tail gate 5 during its swing in a position away from the upright position by an angle of approximately three degrees. The insertion rod 72 has its leading end reaching the conical guide surface 71b. Section (c) of FIG. 9 shows the tail gate 5 as coupled in a position away from the upright position by an angle of approximately zero degrees. The insertion rod 72 has its protruding end entirely in the insertion hole 71a such that the circumferentially welded portion 72a is received in the conical space defined by the conical guide surface 71b.

### Alternative Embodiments

(1) The embodiment described above includes a cargo box 4 with a fixed size. The cargo box 4 may alternatively have an adjustable size.

(2) The embodiment described above includes two elastic coupling units 7 to the left and right of the cargo box 4. The embodiment may alternatively include an additional elastic coupling unit 7 therebetween.

(3) The embodiment described above includes elastic plugs 71 on the tail gate 5 and insertion rods 72 on the side covers 42. The embodiment may alternatively include elastic plugs 71 on the side covers 42 and insertion rods 72 on the tail gate 5.

(4) The embodiment described above is configured such that the elastic plugs 71 are each entirely made of an elastic material. The elastic plugs 71 may alternatively partially include a non-elastic material such as metal. For instance, the elastic plugs 71 may each have a sandwich structure of an elastic material and a non-elastic material.

(5) The embodiment described above is configured such that the elastic plugs 71 are each made of rubber. The elastic plugs 71 may alternatively be made of another elastic material such as a resin material or a structure with a high elastic modulus.

The arrangements disclosed for the above embodiments (including the alternative embodiments; hereinafter the same applies) may each be combined with an arrangement disclosed for another embodiment, as long as such a combination does not cause a contradiction. Further, the embodiments disclosed in the present specification are mere examples. The present invention is not limited to those embodiments, and may be altered as appropriate, as long as such an alteration does not result in a failure to attain an object of the present invention.

### INDUSTRIAL APPLICABILITY

The present invention is applicable to any vehicle with a cargo box 4 movable into a dumping orientation and including a downwardly swingable tail gate 5.

### REFERENCE SIGNS LIST

3 Body frame
4 Cargo box
5 Tail gate
6 Swing mechanism
40 Floor plate
41 Front plate
42 Side cover
51 Gate plate
52 Gate supportive column
7 Elastic coupling unit
71 Elastic plug (elastic material, elastic coupling unit)
71a Insertion hole
71b Conical guide surface
71c Ring-shaped groove
72 Insertion rod (elastic coupling unit)
72a Circumferentially welded portion
91 Slidable pin
92 Hole
LM Lock mechanism
P1 Dump axis
P2 Lateral swing axis

1. A utility vehicle, comprising:
a body frame;
a front wheel and a rear wheel supporting the body frame relative to ground;
a cargo box comprising:
a floor plate;
a pair of left and right side covers; and
a tail gate,
wherein the cargo box is supported by the body frame in such a manner as to be swingable into a dumping orientation;
a swing mechanism configured to swing the tail gate between a closed position and an open position about a lateral swing axis at a lower end area of the tail gate; and
a pair of left and right elastic coupling units each comprising an elastic element and configured to couple the tail gate in the closed position to a corresponding one of the side covers with the elastic element in-between.

2. The utility vehicle according to claim 1, wherein the elastic coupling units each comprise:
as the elastic element, an elastic plug having an insertion hole; and
an insertion rod insertable into the insertion hole as the tail gate swings into the closed position.

3. The utility vehicle according to claim 2, wherein:
the elastic plug has a conical guide surface, and
the insertion hole has a hole diameter equivalent to a diameter of the insertion rod and has an insertion-side opening area so defined by the conical guide surface as to become gradually reduced to the hole diameter.

4. The utility vehicle according to claim 2, wherein:
the insertion rod of the left elastic coupling unit is fixed to a back end portion of the left side cover,
the insertion rod of the right elastic coupling unit is fixed to a back end portion of the right side cover,
the elastic plug of the left elastic coupling unit is fixed to a left end portion of the tail gate, and
the elastic plug of the right elastic coupling unit is fixed to a right end portion of the tail gate.

5. The utility vehicle according to claim 4, wherein:
the insertion rods are off a line of flow of loading and unloading a cargo onto and from the floor plate.

6. The utility vehicle according to claim 1, further comprising:
a pair of left and right lock mechanisms configured to lock the tail gate in the closed position to the respective side covers,
wherein the lock mechanisms each comprise:
a first lock member; and
a second lock member configured to receive the first lock member, and
wherein, with the elastic coupling units each coupling the tail gate to the corresponding one of the side covers, the first lock member is apart from the second lock member by a gap smaller than maximum elastic deformation of the elastic coupling unit.
